(19) United States
(12) Patent Application Publication
(10) Pub. No.: US 2004/0068404 A1
(43) Pub. Date: Apr. 8, 2004

(54) Speech transcoder and speech encoder

(76) Inventors: Masakiyo Tanaka, Kawasaki (JP); Yasuji Ota, Kawasaki (JP); Masanao Suzuki, Kawasaki (JP); Yoshiteru Tsuchinaga, Fukuoka (JP)

Correspondence Address: KATTEN MUCHIN ZAVIS ROSENMAN, 575 MADISON AVENUE, NEW YORK, NY, 10022-2585, US

(21) Appl. No.: 10/635,235

(22) Filed: Aug. 6, 2003

(30) Foreign Application Priority Data
Aug. 6, 2002 (JP) 2002-228492

(51) Int. Cl. G10L 19/02; G10L 19/12

(52) U.S. Cl. 704/229; 704/221; 704/230

(57) ABSTRACT

A speech transcoder includes a codebook in which a plurality of algebraic codes conforming to a second encoding method to serve as conversion candidates of the algebraic code of a first speech code, and a limiting unit for limiting the plurality of algebraic codes stored in the algebraic codebook to at least one algebraic code having a value equal to that of embedded data embedded in a second speech code to limit the conversion candidates, a determination unit for determining an element code corresponding to a converted speech code from the limited conversion candidates.

### BACKGROUND OF THE INVENTION

1. Field of the Invention

The present invention relates to a speech encoder (speech encoding device) used in a network such as the Internet, a mobile phone/automobile telephone system, or the like and a speech transcoder (speech code converting device) which embeds arbitrary data when a speech code (voice and/or sound code) encoded by the speech encoder is converted into another speech code. A speech includes a voice and/or a sound.

2. Description of the Related Art

In recent years, with the popularization of computers and the Internet, an “electronic watermark technique” which embeds arbitrary data in multimedia contents (still image, movie, audio, voice, and the like) attracts attentions. The “electronic watermark technique” is a technique which embeds another arbitrary information in multimedia contents themselves such as an image, a movie, and voice by using the characteristics of the sense of human being without adversely affecting the quality of the multimedia contents. The “electronic watermark technique” is often used for copyright protection such that the names of a preparer, a seller, and the like are embedded in contents to prevent illegal copy and data falsification. The “electronic watermark technique” is also used when related information and auxiliary information related to contents are embedded to improve the convenience of using the contents by a user.

Also in the field of speech communications, an attempt to embed such arbitrary information in speech and transmit the speech is made. FIG. 11 is a diagram showing the concept of a speech communications system to which a data embedding technique is applied. In the speech communications system, voice is encoded from the viewpoint of the effective use of communication lines. Arbitrary series data is embedded when voice is encoded by an encoder, and the voice code (speech code) is transmitted to a decoder. The decoder extract the embedded data from the voice code and reproduces voice by a normal decoding process. In this technique, since the data is embedded in the speech code itself, an amount of data transmission does not increase. In addition, data is embedded in such a state that the quality of reproduced voice is not adversely affected. For this reason, the quality of voice to be reproduced when embedding is performed is not considerably different from that when embedding is not performed. According to the data embedding technique, arbitrary data different from voice can be transmitted without increasing an amount of data transmission and adversely affecting the quality. The third party who does not know that data is embedded recognizes communication as normal voice communication and does not recognize the embedded data.

Various data embedding methods are known. In recent years, several methods that embedding arbitrary information in speech codes encoded by a speech encoding method based on CELP (Code-Excited Linear Prediction) algorithm that popularly used in VoIP (Voice over IP) and a mobile telephone system (for example, AMR (Adaptive Multi Rate), G.729A) are proposed.

For example, a technique for embedding arbitrary data in a code “algebraic code” of a fixed codebook or a code “pitch lag code” of an adaptive codebook in the CELP method is proposed. In this technique, arbitrary series data is embedded in the algebraic code or the pitch lag code depending on a certain threshold value. The principle of the CELP method will be briefly described below. The characteristic feature of the CELP is that a linear prediction coefficient (LPC coefficient) representing the vocal tract characteristics of human being and a parameter representing a sound source signal composed of the pitch component and the noise component of voice are efficiently transmitted. In the CELP, it is assumed that the vocal tract of human being is approximated by an LPC synthesis filter H(z) and that the input (sound source signal) of the H(z) can be separated into a pitch period component representing periodicity of voice and a noise component representing randomness. The CELP does not directly transmit an input speech signal (voice signal) to a decoder. The CELP extracts the filter coefficient of the LPC synthesis filter and the pitch period component and the noise component of an excited signal and transmits a quantization index obtained by quantizing the filter coefficient, the pitch period component, and the noise component. In this manner, high-level information compression is realized. The “algebraic code” corresponds to a quantization index obtained by quantizing a noise component, and the “pitch lag code” corresponds to a quantization index obtained by quantizing a pitch period component.

With a rapid increase of the number of users of mobile telephone sets and with the popularization of VoIP, it is expected that communication between different speech communications systems should be popularized. At the present, different speech encoding methods are often used in different speech communications systems, respectively. For example, AMR is employed in W-CDMA. On the other hand, in VoIP, G.729A recommended by ITU-T is popularly used. For this reason, in voice communication between different voice communication systems, a speech code encoded by a voice encoding method used in one voice communication system must be converted into a speech code of a voice encoding method used in the other voice communication system.

### SUMMARY OF THE INVENTION

It is an object of the present invention to provide a speech transcoder in which, when a speech code of a first encoding method is converted into a speech code of a second encoding method, the speech code of the first encoding method can be converted into a speech code of the second encoding method having arbitrary data embedded therein.

It is another object of the present invention to provide a speech transcoder in which, when a speech code of a first encoding method is converted into a speech code of a second encoding method, arbitrary data can be embedded in the speech code of the second encoding method while suppressing sound quality.

It is still another object of the present invention to provide a speech encoder in which, when a speech signal is encoded into speech code, the speech signal can be encoded into a speech code having arbitrary data embedded therein.

The present invention has the following configuration to solve the above problems.

More specifically, one aspect of the present invention provides a speech transcoder which converts a first speech code encoded by a first encoding method into a second speech code encoded by a second encoding method, including: extracting means for extracting embedded data embedded in an element code constituting the first speech code; a codebook storing a plurality of element codes encoded by the second encoding method to serve as conversion candidates of the element code of the first speech code; limiting means for limiting the plurality of element codes stored in the codebook to at least one element code having a value equal to that of the embedded data extracted by the extraction means at a predetermined position to limit the conversion candidates; and determination means for determining an element code corresponding to a converted speech code in the conversion candidates limited by the limiting means.

Another aspect of the present invention provides a speech transcoder, wherein preferably each of all or some of the element codes encoded by the first encoding method has the same configuration as that of the element code encoded by the second encoding method, and the embedded data is embedded in a part of the same configuration, and the limiting means limits the conversion candidates to an element code in which the value at the same position as an embedding position of the data embedded in the element code encoded by the first encoding method is equal to the value of the embedded data.

Still another aspect of the present invention provides a speech transcoder which converts a first speech code encoded by a first encoding method into a second speech code encoded by a second encoding method, including: a codebook in which a plurality of element codes conforming to the second encoding method and serving as conversion candidates of the element code constituting the first speech code; limiting means for limiting the plurality of element codes stored in the codebook to at least one element code having a value equal to that of the embedded data embedded in the second speech code at a predetermined position to limit the conversion candidates; and determination means for determining an element code corresponding to a converted speech code in the conversion candidates limited by the limiting means.

Still another aspect of the present invention provides a speech transcoder, wherein the determination means preferably determines an element code obtained by encoding, in conformity to the second encoding method, an inverse quantization value having a minimum error with respect to an inverse quantization value of the element code constituting the first speech code as an element code corresponding to the converted speech code.

Still another aspect of the present invention provides a speech encoder for encoding a speech signal into a speech code including:

a codebook storing a plurality of element codes obtained by encoding a specific component of the speech signal;

limiting means for limiting the plurality of element codes stored in the codebook to at least one element code having a value equal to that of embedded data embedded in the speech code at a predetermined position to limit the encoding candidates of the specific component; and determination means for determining an element code corresponding to an encoded speech code of the specific component in the encoding candidates limited by the limiting means.

The present invention can also be specified as the speech transcoder described above, a speech transcoding method having the same characteristic feature of a speech encoder, or a speech encoding method.

### BRIEF DESCRIPTION OF THE DRAWINGS

FIG. 1 is a diagram of the principle of the first aspect of the present invention;

FIG. 2 is a diagram of the configuration of a speech transcoding unit according to the first aspect;

FIG. 3 is a diagram of a speech transcoder according to the first aspect;

FIG. 4 is a diagram showing the structure of an algebraic codebook of ITU-T G.729A;

FIG. 5 is a diagram showing the configuration of an algebraic code of ITU-T G.729A;

FIG. 6 is a diagram of the configuration of an algebraic codebook of AMR (12.2 kbps mode), and the configuration of an algebraic code of AMR (12.2 kbps mode);

FIG. 7 is a diagram of the principle of the second aspect of the present invention;

FIG. 8 is a diagram of the configuration of a speech transcoding unit according to the second aspect;

FIG. 9 is a diagram of a speech transcoder according to the second aspect;

FIG. 10 is a diagram for explaining an embodiment of a speech encoder;

FIG. 11 is a diagram of the concept of a speech communications system to which a data embedding technique is applied;

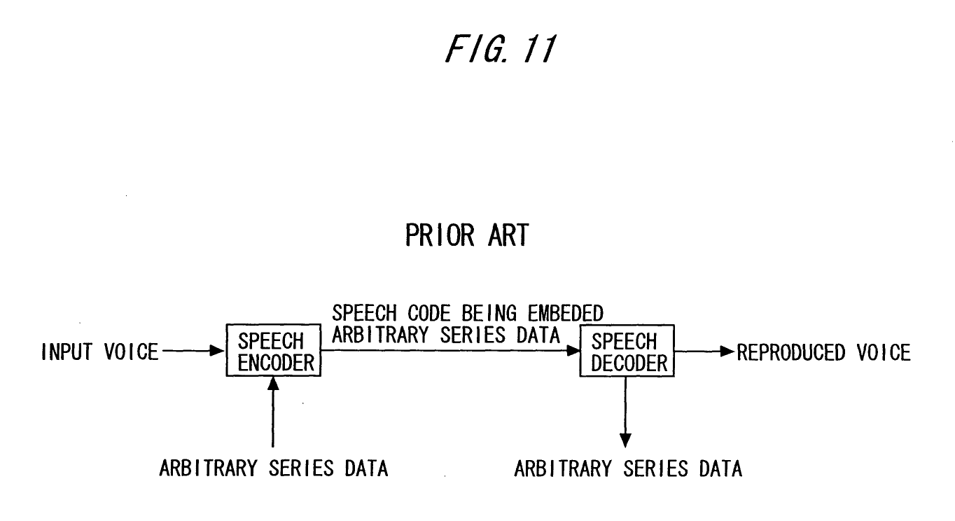

FIG. 12 is a diagram of the concept of a speech transcoder;

FIG. 13 is a diagram of the configuration of a speech transcoder;

FIG. 14 is a diagram of the concept of a speech transcoding unit;

FIG. 15 is a diagram of the principle of a speech transcoder which does not deteriorate source embedded data;

FIG. 16 is a diagram of the principle of a speech transcoder which does not deteriorate source embedded data;

FIG. 17 is a diagram of the principle of a speech transcoder which embeds arbitrary data in code conversion; and

FIG. 18 is a diagram of the concept of a speech transcoder which embeds arbitrary data in code conversion.

### DESCRIPTION OF THE PREFERRED EMBODIMENTS

The embodiments of the present invention will be described below referring to the accompanying drawings. The configurations of the embodiments are specific examples, though the present invention is not limited to the configurations.

### Course of the Invention

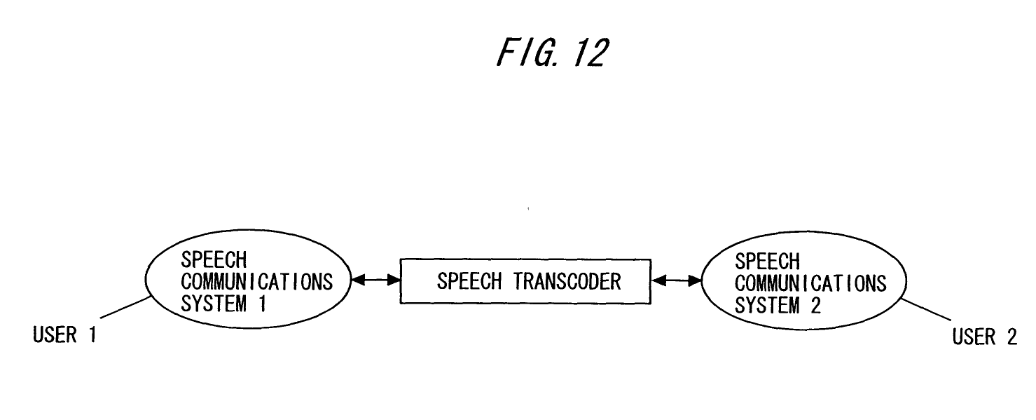

FIG. 12 is a diagram showing the concept of a speech transcoding system including a speech transcoder for converting a speech code between voice communication systems. As a technique for converting a speech code, the following method is proposed:

(1) a tandem connection method which repeats decoding/encoding by the voice encoding methods of respective voice communication systems; and

(2) a method which decomposes a speech code into element codes constituting the speech code and converts the element codes into codes of another voice encoding method (Japanese Patent Application No. 2001-75427, no publication).

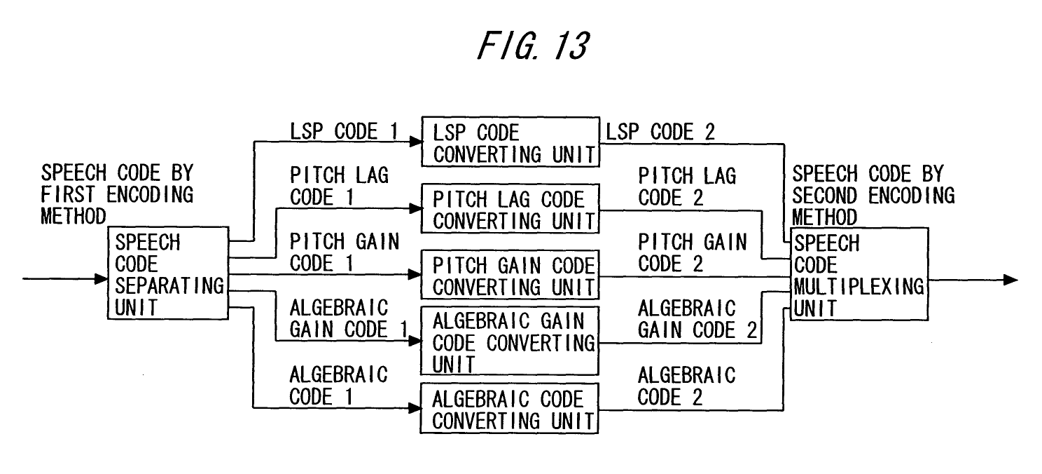

FIG. 13 is a diagram showing a speech transcoding method according to the method (2). As shown in FIG. 13, a speech code of a first encoding method is decomposed into a plurality of element codes including an LSP (linear spectrum pair) code (LSP code 1), a pitch lag code (pitch lag code 1), a pitch gain code (pitch gain code 1), an algebraic gain code (algebraic gain code 1), and an algebraic code (algebraic code 1) in a speech code decomposing unit. These codes are input to corresponding conversion units (LSP transcoding unit, pitch lag transcoding unit, pitch gain transcoding unit, algebraic gain transcoding unit, and algebraic transcoding unit), respectively. The respective transcoding units convert the input corresponding element codes into element codes depending on a second encoding method and output the resultant element codes. The plurality of output element codes (LSP code 2, pitching lag code 2, pitch gain code 2, algebraic gain code 2, and algebraic code 2) are input to a speech code multiplexing unit and multiplexed in the speech code multiplexing unit. The multiplexed codes are output as speech codes of the second encoding method.

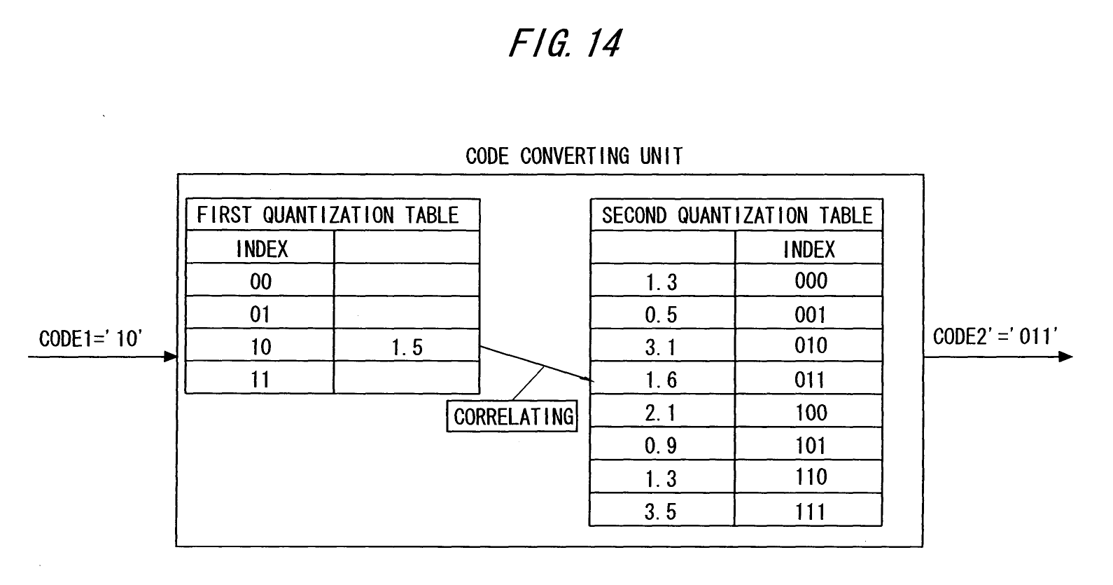

FIG. 14 is a conceptual diagram obtained when respective element codes are converted by the speech transcoding method shown in FIG. 13. FIG. 14 shows a transcoding unit for converting encoding data Code1 of a first encoding method into encoding data Code2 of a second encoding method. In FIG. 14, the transcoding unit comprises a first quantization table used in the first encoding method and a second quantization table used in the second encoding method. The table sizes and the table values of quantization tables are different in different encoding methods. In FIG. 14, for descriptive convenience, the table size of the first quantization table is set to be 2 bits, and the table size of the first quantization table is set to be 3 bits. A speech code Code1 (“10” in FIG. 14) of the first encoding method input to the transcoding unit represents an index number of the first quantization table. The transcoding unit selects a table value (“1.6” in FIG. 14) having the minimum error for the table value (“1.5” in FIG. 14) of the first quantization table corresponding to the input speech code Code1 from the second quantization table, and outputs an index number (“011” in FIG. 14) of the second quantization table corresponding to the selected table value as a speech code Code2 of the second encoding method. In this manner, the transcoding unit compares the source quantization table with the converted quantization table and coordinates the index numbers such that errors of the table values are minimized. The transcoding unit outputs an index number corresponding to the table value having the minimum error.

When arbitrary data is embedded in the source speech code Code 1, the embedded data may be damaged in case Code 1 is transcoded in consideration of only speech quality. In this case, the embedded data maybe damaged. For example, when the series data “10” of the speech code Code1 is arbitrary data embedded by the embedding method, the transcoding process converts the input series data “10” into “011”. Therefore, the embedded series data “10” is not maintained. For this reason, a decoder of the second encoding method on the reception side cannot normally receive the embedded series data.

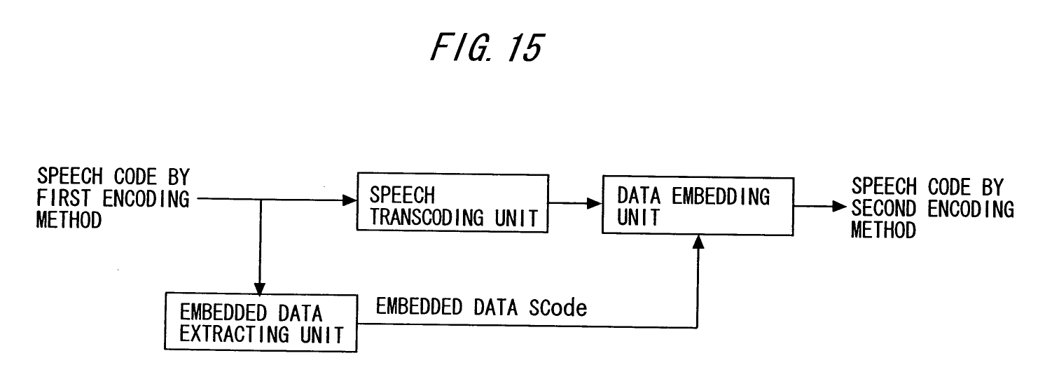

As a means for solving the above problem, a method which temporarily extracts arbitrary data embedded in a source speech code and embeds the data in a converted code after the transcoding process again is proposed. FIG. 15 is a diagram of the principle of a speech transcoder which does not damage the source embedded data. The speech transcoder shown in FIG. 15 has an embedded data extracting unit, a speech transcoding unit, and a data embedding unit. The embedded data extracting unit extracts embedded data Scode from the speech code of the first encoding method. The data embedding unit embeds the embedded data Scode in the speech code converted into code of the second encoding method by the speech transcoding unit. In this manner, the speech code subjected to the conversion process holds the embedded data.

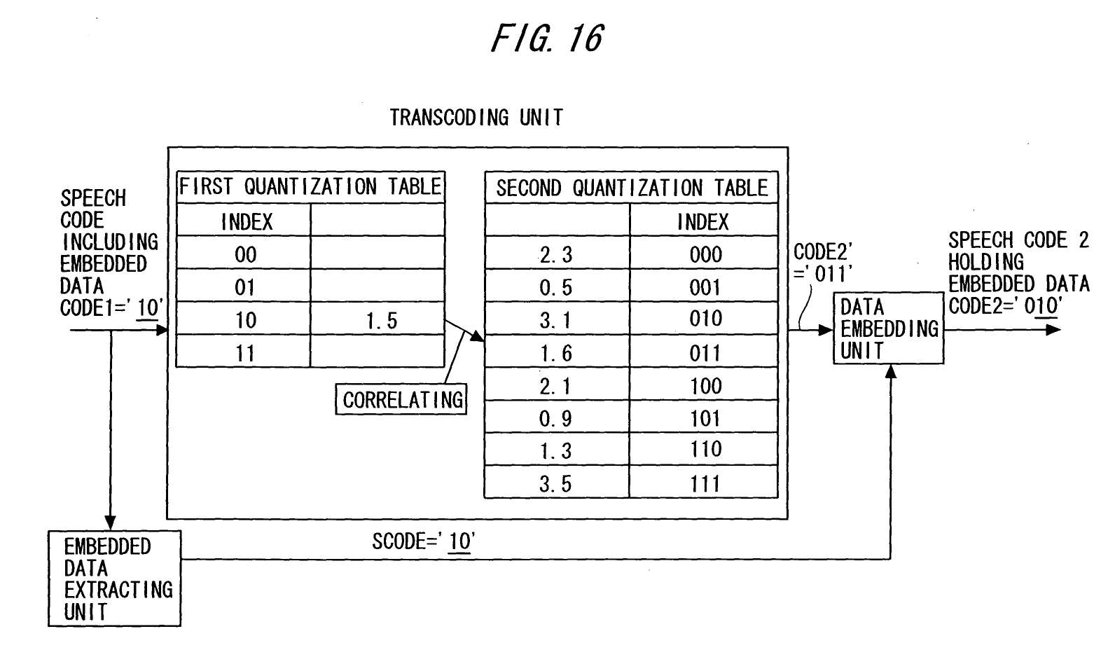

FIG. 16 is a diagram for explaining the details of the speech transcoder shown in FIG. 15. FIG. 16 shows a case in which the speech code Code1 of the first encoding method is converted into the speech code Code2 of the second encoding method. The transcoding unit shown in FIG. 16 has the same configuration and the same functions as those of the transcoding unit shown in FIG. 14. In FIG. 16, the speech code Code1 (“10” in FIG. 16) of the first encoding method input to the transcoding unit represents an index number of the first quantization table. Lower n bits of the series data constituting the speech code Code1 represents embedded arbitrary series data (in this case, the explanation is made on the assumption that n=2 for descriptive convenience) A speech code Code2′ output from the transcoding unit represents an index number of the second quantization table. On the other hand, speech code Code2 output from the data embedding unit represents an index number of the second quantization table. Lower n bits of series data constituting the speech code Code2 represent embedded series data. An operation of the speech transcoder shown in FIG. 16 will be described below. The speech code Code1 (“10” in FIG. 16) is input to the transcoding unit and the embedded data extracting unit. The embedded data extracting unit extracts the embedded data Scode (“10” in FIG. 16) embedded in the speech code Code1 and inputs the embedded data Scode to the data embedding unit. The data embedding unit embeds the embedded series data SCode in the lower n bits of the code Code2′ (“011” in FIG. 16) obtained by converting the code Code1 by the transcoding unit and outputs an encoding data Code2 (“010” in FIG. 16) of the second encoding method.

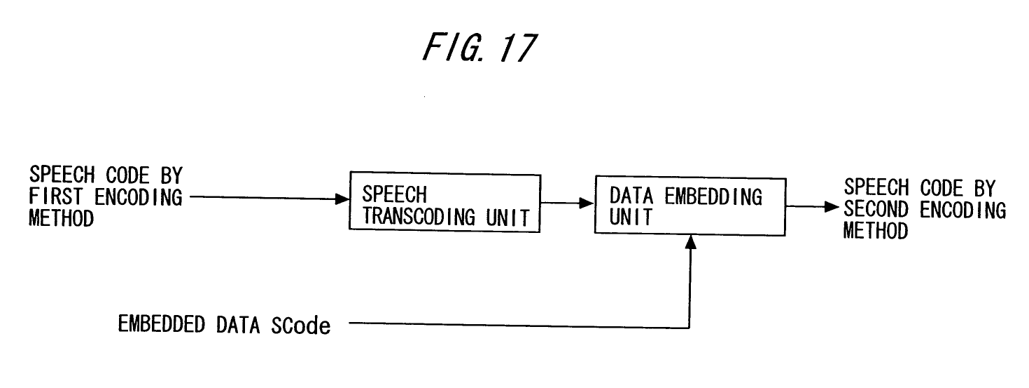

In the future, as typified by the third-generation mobile phone system, a communication system which targets at multimedia information of voice communication, data communication, and the like is expected to be popularized. For this reason, communication is made between a communication system having a conventional voice circuit and a communication system having a voice circuit and another data circuit. In this case, when a conventional speech transcoder performs mutual conversion of a speech code between communication systems, voice communication can be performed between users. However, since one communication system does not have a data circuit, data communication cannot be performed between users. For this problem, a countermeasure shown in FIG. 17 is proposed. FIG. 17 is a conceptual diagram of a speech transcoder which embeds arbitrary data in the converted speech code 2 when a speech code (speech code 1) of the first encoding method is converted into a speech code (speech code 2) of the second encoding method. In FIG. 17, the speech transcoder has a speech transcoding unit and a data embedding unit. The speech transcoding unit performs a transcoding process of converting the speech code of the first encoding method into the speech code of the second encoding method. The data embedding unit embeds arbitrary data in the speech code (converted speech code 2) subjected to the transcoding process. In this manner, data to be transmitted is embedded in the converted speech code 2, and transferred to a destination. When the method is applied, data communication can be executed between a user of a communication system having only a voice circuit and a communication system having a voice circuit and another data circuit.

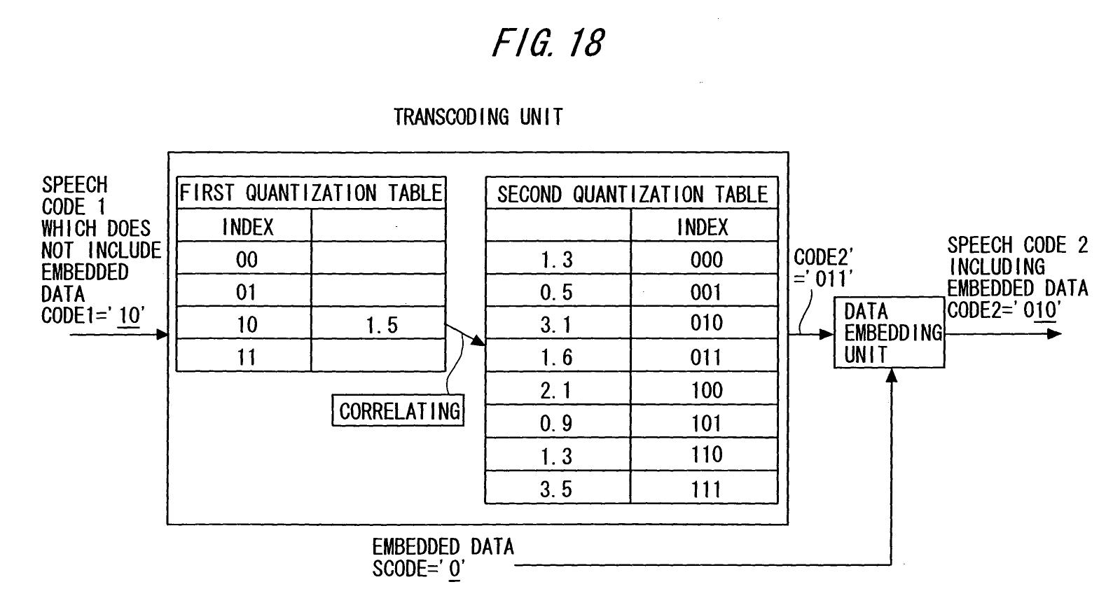

FIG. 18 is a conceptual diagram of a speech transcoder (speech transcoding unit (transcoding unit) and data embedding unit) for embedding arbitrary data in a converted speech code by using the method shown in FIG. 17. FIG. 18 shows a speech transcoder including a transcoding unit for converting a speech code Code1 of the first encoding method into a speech code Code2 of the second encoding method. The transcoding unit shown in FIG. 18 has the same configuration and the same functions as those of the transcoding unit shown in FIG. 14. In FIG. 18, a speech code Code1 (“10” in FIG. 18) of the first encoding method input to the transcoding unit represents an index number of the first quantization table. A speech code Code2′ output from the transcoding unit represents an index number of the second quantization table. The speech code Code2 output from the data embedding unit represents an index number of the second quantization table. In addition, the lower m bits of series data constituting the speech code Code2 represent embedded series data. In this case, for descriptive convenience, it is assumed that m=1 is satisfied. In FIG. 18, the transcoding unit performs the same process as that of the transcoding unit shown in FIG. 14. More specifically, the speech code Code1 (“10”) of the first encoding method is converted into the speech code Code2′ (“011”) of the second encoding method and inputs the speech code Code2′ to the data embedding unit. The data embedding unit embeds the series data Scode (embedded data (“0” in FIG. 18)) input from the data circuit in the lower m bits of the speech code Code2′. The data embedding unit outputs the series data “010” generated by embedding data as the speech code Code2 of the second encoding method.

In the system (system 1) shown in FIG. 16, the data extracting unit temporarily extracts the embedded data Scode included in the speech code Code1, and the data embedding unit embeds the extracted embedded data Scode in the speech code Code2′ subjected to the transcoding process by the transcoding unit. In this manner, the transcoding is realized without damaging the embedded data. However, in the system 1, the value of the speech code changes by embedding data. For this reason, an error between a value of the first quantization table corresponding to the speech code Code 1 (table value “1.5” corresponding to “10” in FIG. 16) and a value of the second quantization table corresponding to the speech code Code2 (table value “3.1” corresponding to “010” in FIG. 16) output from the speech transcoder may increase. Therefore, voice distortion generated when the Code2 is decoded into voice becomes large, and voice quality may be deteriorated.

On the other hand, in the system (system 2) shown in FIG. 18, arbitrary data is embedded in the speech code Code2′ obtained by converting the speech code Code1. However, even in the method according to the system 2, the value of the speech code changes by embedding data. For this reason, an error between the value (table value “1.5” corresponding to “10” in FIG. 18) of the first quantization table corresponding to the speech code Code1 and the value (table value “3.1” corresponding to “010” in FIG. 18) of the second quantization table corresponding to the speech code Code2 may increase. For this reason, voice distortion generated when the Code2 is decoded into voice becomes large, and voice quality may be deteriorated. As described above, in the systems 1 and 2, embedding of data and holding of voice quality cannot be compatible.

### FIRST EMBODIMENT

First, as the first embodiment of the present invention, an embodiment corresponding to the first aspect of the present invention will be described below.

### Outline of First Embodiment

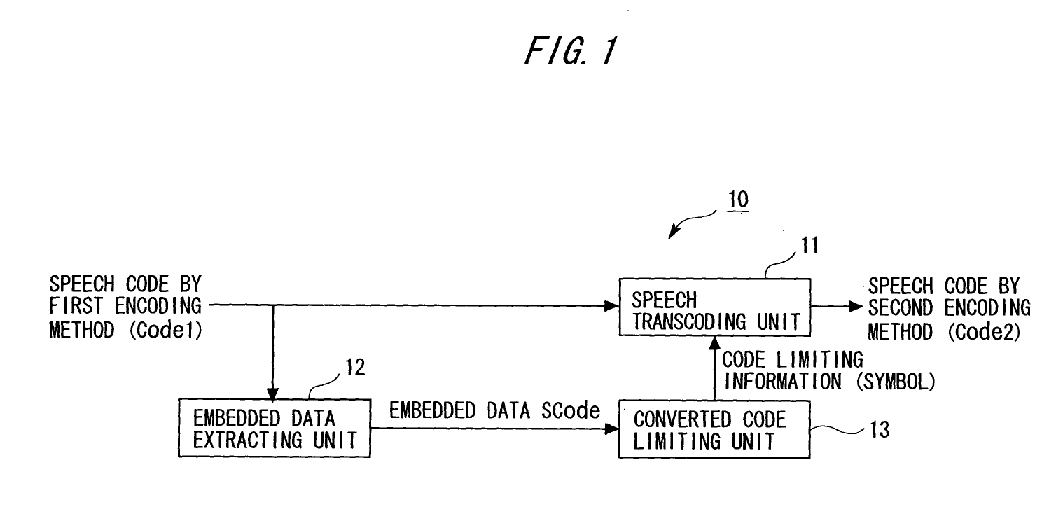

FIG. 1 is a schematic diagram showing a system principle of the first embodiment (speech transcoder 10) of the present invention. FIG. 1 shows the speech transcoder 10 which receives a speech code (speech code “Code 1”) of a first encoding method having data embedded therein and outputs a speech code (speech code “Code2”) of a second encoding method having data embedded therein.

The speech transcoder 10 comprises a speech transcoding unit 11, an embedded data extracting unit 12, and a conversion code limiting unit 13. The speech transcoding unit 11 and the embedded data extracting unit 12 receive speech code Code1. Arbitrary embedded data is embedded in the speech code Code1. The speech transcoding unit 11 converts the speech code Code1 into speech code Code2 conforming to the second encoding method. The embedded data extracting unit 12 extracts the embedded data from the speech code Code1 and inputs the embedded data in the conversion code limiting unit 13. The conversion code limiting unit 13 uses the embedded data input from the embedded data extracting unit 12 as code limiting information to limit candidates of a converted speech code (speech code Code2) of the speech code Code1.

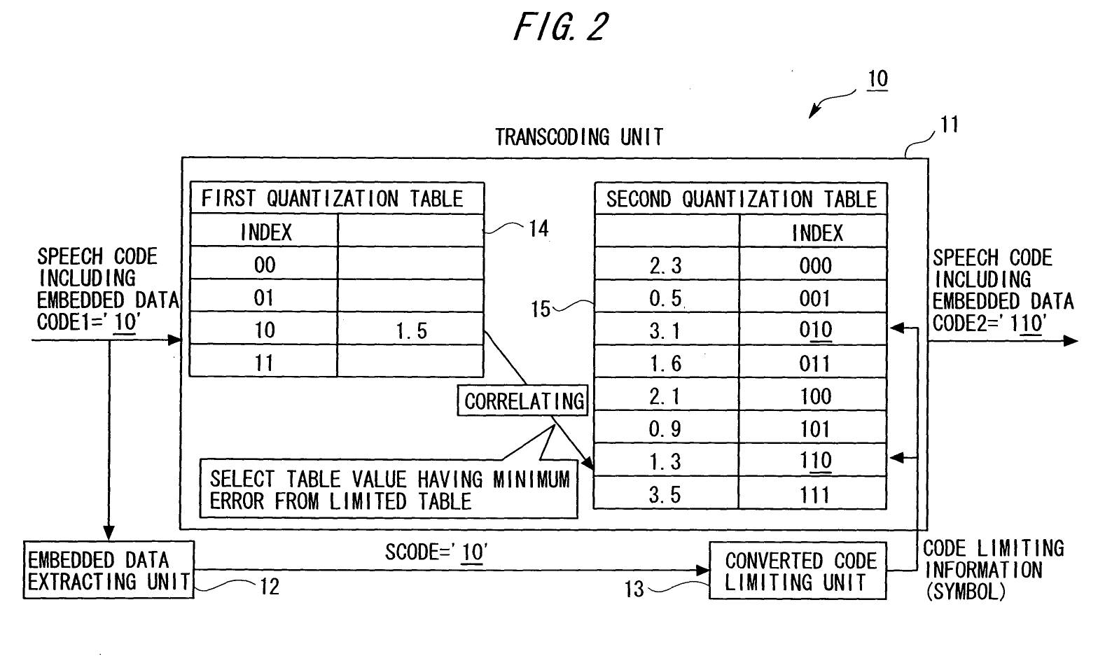

FIG. 2 is a diagram showing the speech transcoder 10 shown in FIG. 1 in detail. FIG. 2 shows the concept of the speech transcoding unit 11 which converts the speech code having the data embedded therein without damaging the embedded data. In FIG. 2, the speech transcoding unit 11 includes a first quantization table 14 and a second quantization table 15.

The first quantization table 14 has at least one table value. An index number (quantization index) is allocated to each table value. The table value represents an inverse quantization value (decode value) of the speech code, and the index number constitutes a speech code obtained by encoding the table value. The index number of the first quantization table 14 is set in conformity to the first encoding method. In the example shown in FIG. 2, the index number of the first quantization table 14 is expressed by 2 bits.

The second quantization table 15, like the first quantization table 14, has at least one table value. An index number (quantization index) is allocated to each table value. The table value represents an inverse quantization value (decode value) of the speech code, and the index number constitutes a speech code obtained by encoding the corresponding table value. The index number of the second quantization table 15 is set in conformity to the second encoding method. In the example shown in FIG. 2, the index number of the first quantization table 14 is expressed by 3 bits.

The speech code Code1 (Code1=“10” in FIG. 2) encoded in conformity of the first encoding method is input to the speech transcoding unit 11. The speech code Code1 represents an index number of the first quantization table 14. Lower n bits of series data constituting the speech code Code1 represent arbitrary series data embedded in the speech code Code1. On the other hand, the speech transcoding unit 11 output the speech code Code2. The speech code Code2 is a speech code obtained by converting the speech code Code1 in conformity to the second encoding method. The speech code Code2 represents an index number of the second quantization table 15. Lower n bits of series data constituting the speech code Code2 represent embedded series data embedded in the speech code Code2.

An operation of the speech transcoder 10 will be described below with reference to FIG. 2. The speech code Code1 (“10”) is input to the speech transcoding unit 11 and the embedded data extracting unit 12. The embedded data extracting unit 12 extracts the embedded data SCode (SCode=“10” in FIG. 2) embedded in the speech code Code1 to input the embedded data Scode in the conversion code limiting unit 13.

The conversion code limiting unit 13 inputs code limiting information in the speech transcoding unit 11. The code limiting information is information for limiting all the index numbers stored in the second quantization table 15 to an index number including the embedded data Scode at a predetermined position as the conversion candidate of the speech code Code1.

In the example shown in FIG. 2, the code limiting information includes information representing that the index number of the conversion candidate to at least one index number having a value equal to a value (“10”) of the embedded data Scode as the value of lower n bits. Therefore, the index number of the conversion candidate in the second quantization table 15 is limited to an index number having a value (“10”) equal to that of the embedded data Scode as lower n bits, i.e., index number “010” and index number “110”.

The speech transcoding unit 11 converts a speech code of the first encoding method into a speech code of the second encoding method by the following procedure. More specifically, when the speech transcoding unit 11 receives the speech code Code1, the speech transcoding unit 11 receives a table value corresponding to the index number having a value equal to that of the speech code from the first quantization table 14. The speech transcoding unit 11 determines (selects) a table value having a minimum error with respect to the table value read from the first quantization table 14 with reference to the second quantization table 15, and outputs the index number of the determined table value as the speech code Code2. At this time, a table value which can be selected by the speech transcoding unit 11 is limited to the table value corresponding to the index number limited by the conversion code limiting unit 13. Therefore, the speech transcoding unit 11 selects the table value having the minimum error from the limited table values, and outputs the index number of the selected table value to the outside as the speech code Code2. In the example shown in FIG. 2, the speech transcoding unit 11 selects a table value “1.3” of the second quantization table 15 as a table value having a minimum error with respect to a table value (“1.5”) of the first quantization table 14 corresponding to the speech code Code1 (“10”), and outputs an index number “110” of the table value “1.3” as the speech code Code2. The speech code Code2 includes embedded series data “10” in lower n bits.

In this manner, in the first aspect of the present invention, the speech code Code1 of the first encoding method is converted into the speech code Code2 of the second encoding method including the embedded data Scode included in the speech code Code1 at the predetermined position. For this reason, in the speech code Code2 converted from the speech code Code1, the embedded series data Scode embedded in the speech code Code1 is maintained.

In other words, the conversion code limiting unit 13 limits a candidate of transcoding used in the transcoding process performed by the speech transcoding unit 11 depending on embedded data. More specifically, the conversion code limiting unit 13 limits the plurality of index numbers stored in the second quantization table 15 to only an index number which is set such that the series data of lower n bits of an index number has a value equal to that of the embedded data Scode. For this reason, even though any index number is selected, the index number corresponding to a selection result, i.e., a converted speech code (speech code corresponding to the conversion result) includes the embedded data Scode at the predetermined position. Therefore, the speech code of the first encoding method can be converted into the speech code of the second encoding method without damaging the embedded data embedded in the speech code of the first encoding method.

In addition, the speech transcoding unit 11 determines an index number of a table value having a minimum error with respect to the table value of the first quantization table 14 corresponding to the speech code Code1 from at least one index number corresponding to a conversion candidate, and outputs the determined index number (“110” in FIG. 2) as encoding data (speech code Code2) of the second encoding method. Therefore, deterioration of sound quality caused when the speech code of the second encoding method maintains the embedded series data can be suppressed to a minimum level.

As described above, even though arbitrary data is embedded in the speech code encoded by the first encoding method, the speech code of the first encoding method can be converted into the speech code of the second encoding method without damaging the embedded data while suppressing voice quality.

In the explanation by using FIG. 2, for descriptive convenience, it is assumed that the embedded series data is included in the lower n bits of the speech code. However, in the present invention, a position where the embedded series data is embedded in a speech code and the number of bits constituting the embedded data can be arbitrarily set.

### Concrete Example of First Embodiment

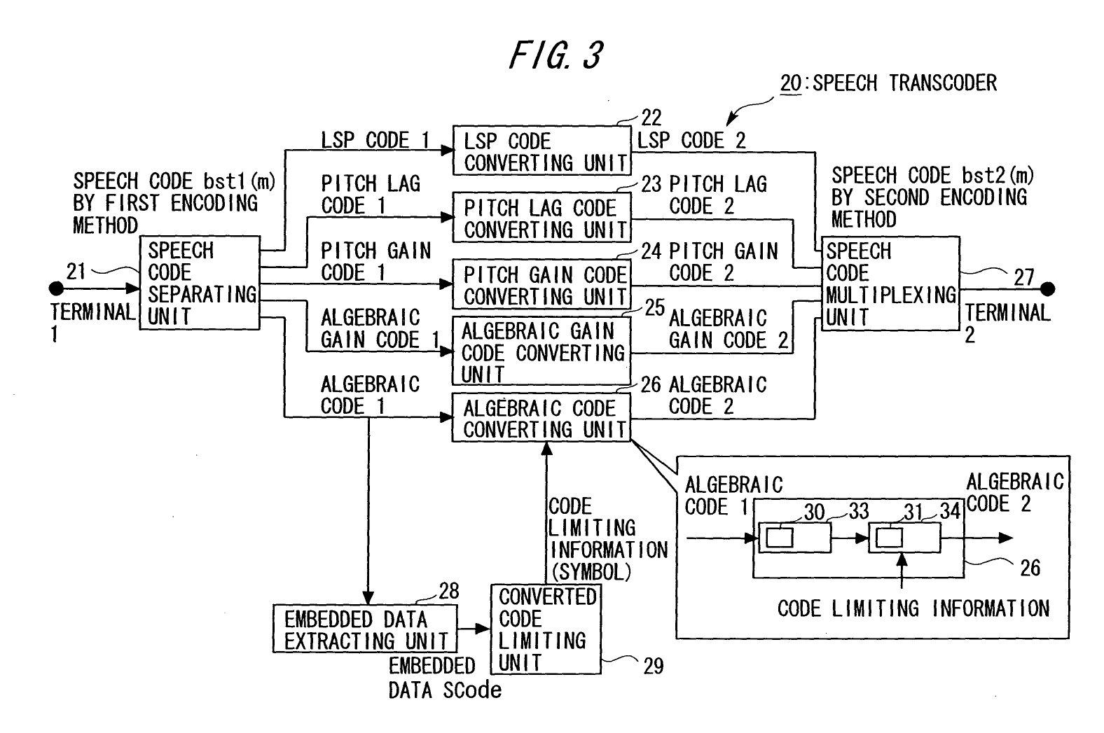

A concrete example of the first embodiment (first aspect) will be described below. FIG. 3 is a diagram of the configuration of a speech transcoder (speech transcoding device) 20 corresponding to the concrete example of the first embodiment. In FIG. 3, the speech transcoder 20 converts a speech code of G.729A corresponding to the first encoding method into a speech code of AMR (12.2-kbps mode) corresponding to the second encoding method. The speech transcoder 20 converts a speech code of G.729A having arbitrary data embedded therein into a speech code of AMR without damaging the embedded data. It is assumed that the embedded data is embedded in an algebraic code (SCB code) of a source speech code of G.729A. The embedded data is embedded in the algebraic code of a converted speech code of AMR.

According to G.729A, a sampling frequency is 8 kHz, a frame length is 10 milliseconds, a sub-frame length is 5 milliseconds, the number of sub-frames is 2, a principle delay is 15 milliseconds, and a linear prediction order is 10th order. On the other hand, according to AMR, the sampling frequency is 8 kHz, a frame length is 20 milliseconds, a sub-frame length is 5 milliseconds, the number of sub-frames is 4, a principle delay is 25 milliseconds, and a linear prediction order is 10th order.

The speech transcoder 20 comprises a speech code separating unit 21, an LSP code converting unit 22, a pitch lag code converting unit 23, a pitch gain code converting unit 24, an algebraic gain code converting unit 25, an algebraic code converting unit 26, an embedded data extracting unit 28, and a converted code limiting unit 29.

Circuit data bst1 (m) of the mth (m is an integer) frame which is an encoder output of G.729A is input to the speech code separating unit 21 through a terminal 1 as a speech code bst1 (m) of the first encoding method. The code separating unit 21 separates the circuit data bst1 (m) into element codes (LSP code, pitch lag code, pitch gain code, algebraic code, and algebraic gain code) of G.729A and inputs the element codes to the respective code converting units 22 to 26 (the LSP code converting unit 22, the pitch lag code converting unit 23, the pitch gain code converting unit 24, the algebraic gain code converting unit 25, and the algebraic code converting unit 26). At this time, the algebraic code output from the speech code separating unit 21 is also input to the embedded data extracting unit 28.

In this case, the LSP code is obtained by quantizing a linear prediction coefficient (LPC coefficient) obtained by linear prediction analysis for each frame or an LSP (Linear Spectrum Pair) parameter calculated from the LPC coefficient. The pitch lag code is a code for specifying an output signal of an adaptive codebook for outputting a periodical sound source signal. The algebraic code (noise code) is a code for specifying an output signal of an algebraic codebook (noise codebook) for outputting a noise sound source signal. The pitch gain code is a code obtained by quantizing a pitch gain (adaptive codebook gain) representing an amplitude of the output signal of the adaptive codebook. The algebraic gain code is a code obtained by quantizing an algebraic gain (noise gain) representing an amplitude of the output signal of the algebraic codebook. A speech code obtained by encoding a speech signal is constituted by the above element codes.

The embedded data extracting unit 28 extracts the embedded data Scode included in the algebraic code and outputs the embedded data Scode to the converted code limiting unit 29. The converted code limiting unit 29 limits an algebraic code of AMR serving as a conversion target (conversion candidate) depending on the embedded data Scode.

Each of the code converting units 22 to 26 converts a corresponding element code of G.729A input from the speech code separating unit 21 into an element code conforming to AMR to input the element code to a speech code multiplexing unit 27. The speech code multiplexing unit 27 multiplexes the element codes of AMR input from the code converting units 22 to 26, and outputs a resultant code as circuit data bst2 (n) of the nth (n is an integer) frame of AMR, i.e., a speech code of the second encoding method.

The LSP code converting unit 22 has an LSP inverse quantizer for inversely quantizing an LSP code (LSP code 1) of G.729A method input from the speech code separating unit 21 and an LSP quantizer for quantizing the inversely quantized value obtained by the LSP inverse quantizer in conformity to the AMR method. The LSP code (LSP code 2) of the AMR method obtained by the LSP quantizer is output to the speech code multiplexing unit 27.

The pitch lag transcoding unit 23 has a pitch lag inverse quantizer for inversely quantizing a pitch lag code (pitch lag code 1) of G.729A method input from the speech code separating unit 21 and a pitch lag quantizer for quantizing the inversely quantized value obtained by the pitch lag inverse quantizer in conformity to the AMR method. The pitch lag code (pitch lag code 2) of the AMR method obtained by the pitch lag quantizer is output to the speech code multiplexing unit 27.

The pitch gain transcoding unit 24 has a pitch gain inverse quantizer for inversely quantizing a pitch gain code (pitch gain code 1) of G.729A method input from the speech code separating unit 21 and a pitch gain quantizer for quantizing the inversely quantized value obtained by the pitch gain inverse quantizer in conformity to the AMR method. The pitch gain code (pitch gain code 2) of the AMR method obtained by the pitch gain quantizer is output to the speech code multiplexing unit 27.

The algebraic gain transcoding unit 25 has an algebraic gain inverse quantizer for inversely quantizing an algebraic gain code (algebraic gain code 1) of G.729A method input from the speech code separating unit 21 and an algebraic gain quantizer for quantizing the inversely quantized value obtained by the algebraic gain inverse quantizer in conformity to the AMR method. The algebraic gain code (algebraic gain code 2) of the AMR method obtained by the algebraic gain quantizer is output to the speech code multiplexing unit 27. Actually, in the AMR method, the inversely quantized value of the pitch gain code and the inversely quantized value of the algebraic gain code are quantized as a gain code at once.

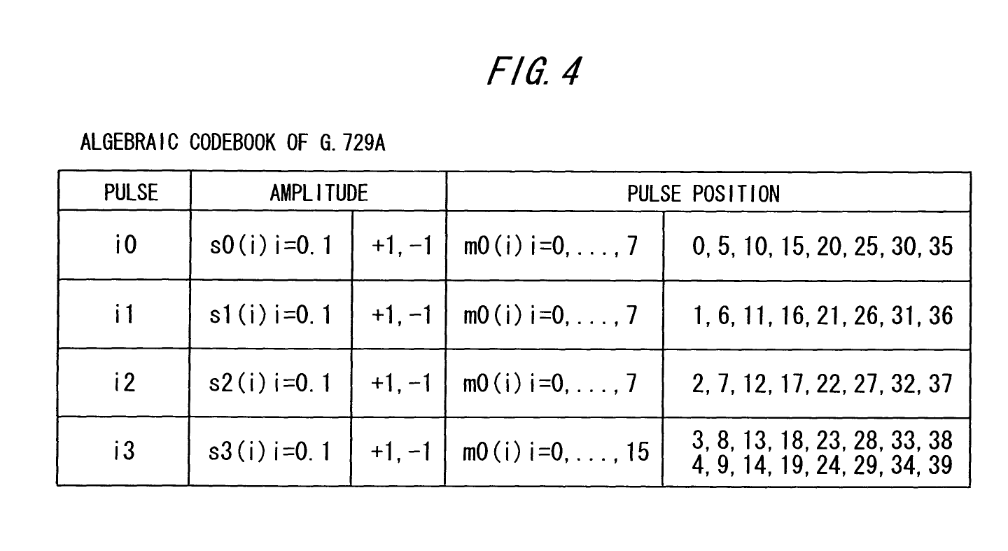

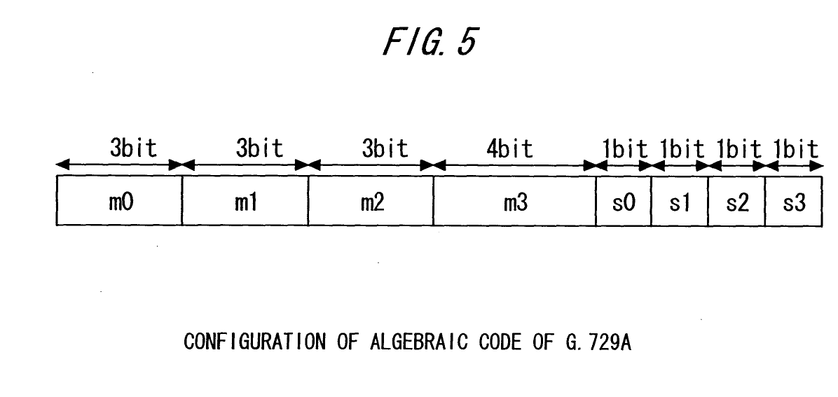

FIG. 4 is a diagram showing the structure of an algebraic codebook 30 of G.729A, and FIG. 5 is a diagram showing the configuration of an algebraic code generated in conformity to G.729A. The algebraic codebook 30 corresponds to the first quantization table 14.

In G.729A, 40 sample points are defined for one sub-frame, and the respective sample points are represented by the positions of pulses. The algebraic codebook 30 classifies sample points N (N=40) constituting one sub-frame into four pulse sequence groups i0, i1, i2, and i3. The algebraic codebook 30 picks up one sample point from each pulse sequence group, and the picked sample points output pulse signals (corresponding to table values) each having a positive or negative amplitude.

Allocation of the sample points to the pulse sequence groups i0, i1, i2, and i3 is performed as shown in FIG. 4. More specifically, (1) 8 sample points 0, 5, 10, 15, 20, 25, 30, and 35 are allocated to the pulse sequence group i0, (2) 8 sample points 1, 6, 11, 16, 21, 26, 31, and 36 are allocated to the pulse sequence group i1, (3) 8 sample points 2, 7, 12, 17, 22, 27, 32, and 37 are allocated to the pulse sequence group i2, (4) 16 sample points 3, 4, 8, 9, 13, 14, 18, 19, 23, 24, 28, 29, 33, 34, 38, and 39 are allocated to the pulse sequence group i3.

The algebraic codebook 30, as shown in FIG. 4, is expressed by positions (m0, m1, m2, and m3) of pulses picked from the pulse sequence groups i0, i1, i2, and i3 and amplitudes (s0, s1, s2, and s3: code ±1). The algebraic codebook 30 stores a plurality of algebraic codes (quantization indexes) obtained by encoding all combinations of the four pulses picked from the four pulse sequence groups and the amplitudes of the pulses, and pulse signals depending on the algebraic codes can be output.

In G.729A, pulse positions m0, m1, and m2 are expressed by 3 bits, a pulse position m3 is expressed by 4 bits, and each of the amplitudes of the pulses m0, m1, m2, and m3 is expressed by one bit. Therefore, an algebraic code generated in conformity to G.729A, as shown in FIG. 5, is constituted by 17 bits constituted by four pieces of pulse position information and four amplitude information. Therefore, the algebraic codebook 30 has 2¹⁷ algebraic codes (quantization indexes).

The embedded data extracting unit 28 extracts embedded data from an algebraic code (algebraic code 1) of G.729A input from the speech code separating unit 21. The embedded data extracting unit 28 knows the data embedding method (the number of bits of embedded series data, embedding position, and the like) performed on the transmission side (G.729A side) of the circuit data bst1 (m), and extracts the embedded data in conformity to the embedding method. In this case, it is assumed that the embedded data is embedded in information fields corresponding to the pulse sequence groups i0, i1, and i2 of the algebraic code (FIG. 5) of G.729A. The embedded data extracting unit 28 cuts pieces of information (m0, m1, m2, s0, s1, and s2) related to the pulse sequence groups i0, i1, and i2 of the algebraic code and extracts the information as the 12-bit embedded data Scode.

The number of bits of the embedded data and the embedding position can be arbitrarily set. According to the configuration of the algebraic code, when a method for embedding data in units of pulse position information, in units of amplitude information, or in units of pulse sequence groups is applied, data embedding or cutting process becomes easy. The embedded data is preferably embedded in units of pulse sequence groups. In particular, the embedded data is preferably embedded in a combination including at least one of the pulse sequence groups i0 to i2. The embedded data Scode may be embedded at any point of time in a period of time from the speech code 62 data bst1(m) is generated to when the same is input in the speech transcoder 20.

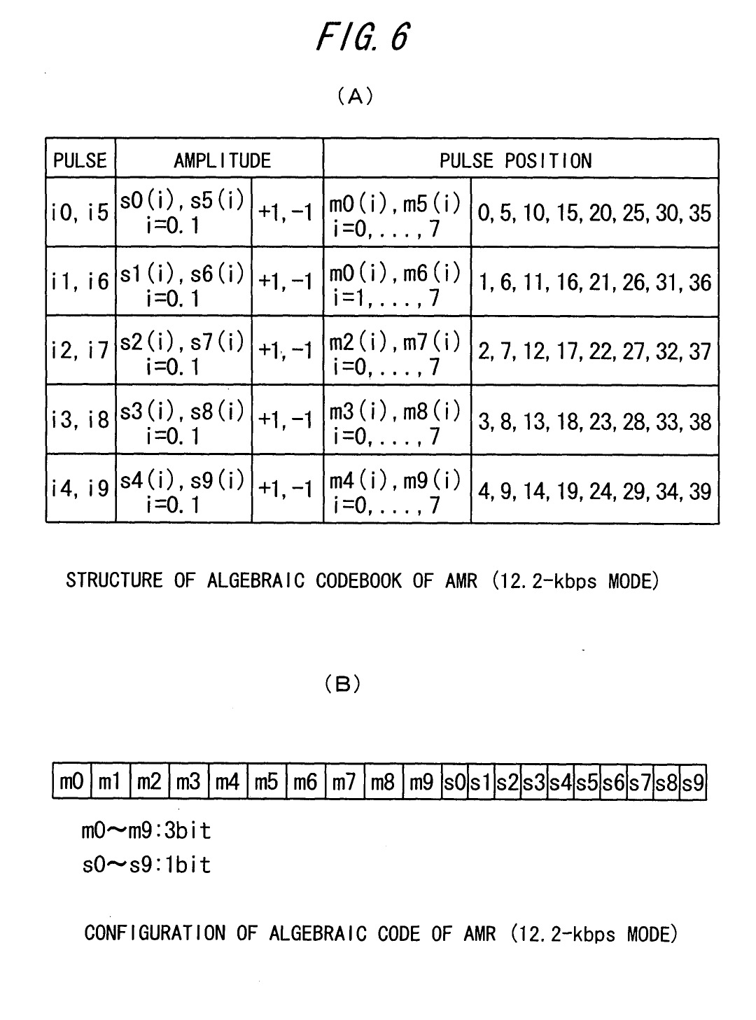

The converted code limiting unit 29 will be described below. FIG. 6(A) is a diagram showing the configuration of an algebraic codebook 31 of AMR (12.2 kbps mode) which is a destination of conversion. FIG. 6(B) is a diagram showing the configuration of an algebraic code of AMR (12.2 kbps mode). The algebraic codebook 31 corresponds to the second quantization table 15.

In AMR (12.2 kbps mode), as in G.729A, 40 sample points are set for one sub-frame (5 milliseconds), and the sample points are allocated to the pulse sequence groups i0 to i9 as shown in FIG. 6(A).

The algebraic codebook 31 can output pulses respectively picked from the 10 pulse sequence groups (i0 to i9) and a pulse signal constituted by combinations of the amplitudes (positive or negative) of these pulses with respect to all the combinations. As shown in FIG. 6(A), the algebraic codebook 31 is expressed by the positions (m0 to m9) of the pulses respectively picked from the 10 pulse sequence groups i0 to i9 and the amplitudes (s0 to s9; 1 (positive) or −1 (negative)) of these pulses. The position of the pulse is expressed by 3 bits, and the amplitude of the pulse is expressed by one bit. Therefore, the algebraic code of AMR (12.2 kbps mode), as shown in FIG. 6(B), is constituted by 40 bits constituted by the pieces of position information m0 to m9 of the pulses and the pieces of amplitude information s0 to s9 representing the amplitudes of the pulses. The algebraic codebook 31 stores 2⁴⁰ quantization indexes of pulse signals (corresponding to table values) corresponding to all combinations of the positions of the pulses and the amplitudes, i.e., algebraic codes, and outputs pulse signals obtained by decoding the algebraic codes. The plurality of algebraic codes stored in the algebraic codebook 31 can be conversion candidates of algebraic codes of G.729A.

When the algebraic codebook 31 is compared with the algebraic codebook 30, the configuration related to the pulse sequence groups i0 to i2 of G.729A is equal to the configuration related to the pulse sequence groups i0 to i2 of AMR (12.2 kbps). Therefore, the embedded data Scode is preferably embedded in a part (information field) related to the pulse sequence groups i0 to i2 of the algebraic codes of G.729A. This is because the values of the pulse sequence groups in source algebraic codes can be made equal to those in converted algebraic codes. In this manner, the quality of voice obtained by a converted speech code can be made close to the quality of a source speech code.

When the embedded data Scode is input to the converted code limiting unit 29, on the basis of the embedded data Scode and information related to the embedding position of the embedded data Scode to algebraic code 2 which is recognized in advance, the converted code limiting unit 29 inputs code limiting information for limiting an algebraic code (quantization index) of the algebraic codebook 31 in the algebraic code converting unit 26.

The code limiting information in this example includes information representing that the plurality of algebraic codes stored in the algebraic codebook 31 are limited to an algebraic code having values of groups i0, i1, and i2 which are equal to those of the embedded data Scode. The algebraic code limited by the code limiting information must include embedded data. The limited algebraic code is used as a conversion candidate of algebraic code 1 in a searching operation of the algebraic codebook in the algebraic code converting unit 26.

Since the algebraic codes are limited to an algebraic code having values of groups i0, i1, and i2 which are equal to those of the embedded data Scode, the converted algebraic code has the values of the groups i0, i1, and i2 which are fixed. When the values of the groups i0, i1, and i2 of algebraic code 2 are fixed, the number of converted algebraic codes (quantization indexes) which can be selected from the algebraic codebook 31 decreases from 2⁴⁰ to 2²⁸.

Returning to FIG. 3, the algebraic code converting unit 26 will be described below. The algebraic code converting unit 26 includes an algebraic code inverse quantizer 33 for inversely quantizing an algebraic code (algebraic code 1) of G.729A and an algebraic code quantizer 34 for quantizing an inversely quantized value (algebraic codebook output of the algebraic codebook 31) obtained by the algebraic code inverse quantizer 33.

The algebraic code inverse quantizer 33 inversely quantizes (decodes) an algebraic code by the same method as a decoding method of an algebraic code of G.729A. More specifically, the algebraic code inverse quantizer 33 has the algebraic codebook 30 described above and inputs a pulse signal (algebraic codebook output of the algebraic codebook 30) corresponding to algebraic code 1 input to the algebraic code inverse quantizer 33 into the algebraic code quantizer 34.

The algebraic code quantizer 34 encodes (quantizes) the pulse signal (algebraic codebook output from the algebraic codebook 30) from the algebraic code inverse quantizer 33 in conformity to AMR. More specifically, the algebraic code quantizer 34 has the algebraic codebook 31 described above, and determines algebraic code 2 corresponding to the converted code of algebraic code 1 from the plurality of algebraic codes stored in the algebraic codebook 31. In this case, the algebraic code 2 corresponding to the converted code is determined from the algebraic codes including the embedded data Scode limited by the converted code limiting unit 29.

In other words, the algebraic code quantizer 34 selects a combination (algebraic codebook output) of 10 optimum pulses which can minimize deterioration of voice quality by code converting (transcoding) from the algebraic codebook 31 of AMR having quantization indexes limited by the converted code limiting unit 29. At this time, the algebraic code quantizer 34 determines pulse positions and amplitudes to the remaining groups i3 to i9 under the condition that the values of the pulse sequence groups i0, i1, and i2 limited by the converted code limiting unit 29 are fixed.

A method of determining the remaining pulse sequence groups will be described below. The algebraic code quantizer 34 determines a combination of pulses having a minimum error power in a reproduction area with respect to a reproduced signal of G.729A from the algebraic codebook of AMR limited by the converted code limiting unit 29.

First, the algebraic code quantizer 34 calculates a reproduced signal X from element parameters (LSP, pitch lag, pitch gain, algebraic codebook output, and algebraic gain) of G.729A generated by inversely quantizing corresponding element codes in the code converting units 22 to 26.

The algebraic code quantizer 34 calculates an adaptive codebook output P_{L} of AMR generated by the pitch lag code converting unit 23 and a pitch gain βₒₚₜ of AMR generated by the pitch gain converting unit 24 by reproduced signal X, and calculates LPC coefficient calculated from an LSP coefficient of AMR generated by the LSP code converting unit 22.

The algebraic code quantizer 34 generates target vector (target signal) X′ for searching for an algebraic codebook of the algebraic codebook 31 expressed by the following equation (1) from the adaptive codebook output P_{L}, the pitch gain βₒₚₜ, and an impulse response A of an LPC synthesis filter constituted by the LPC coefficient.

### [Equation 1]

X′=X−βₒₚₜAP_{L} (1)

The algebraic code quantizer 34 calculates, as an algebraic codebook searching operation, a code vector for outputting an algebraic codebook output C set such that an evaluation function error power D in Equation (2) is minimum.

### [Equation 2]

D=|X′−γAC|² (2)

In Equation (2), γ denotes an algebraic gain of AMR generated by the algebraic code converting unit 26. To search for a code vector which outputs the algebraic codebook output C for minimizing the error power D in Equation (2) is equivalent to search for the algebraic codebook output C for maximizing an error power D′ in the following Equation (3).

### Euation 3

$${D}^{′} = \frac{{( {X}^{′ T} A C )}^{2}}{{( A C )}^{T} ( A C )} \qquad ( 3 )$$

In this equation, when φ=A^{T}A and d=X′^{T}A are satisfied, Equation (3) can be expressed by the following Equation (4).

### Equation 4

$${D}^{′} = \frac{{( dC )}^{2}}{{C}^{T} Φ C} = \frac{{Q}^{2}}{E} \qquad ( 4 )$$

In this equation, when impulse response of LPC synthesis filter A=[a(0), . . . , a(N−1)], and when target vector X′=[x′(0), . . . , x′(N−1)], d in Equation (4) and element φ(i,j) of φ can be expressed by Equation (5) and Equation (6), respectively. N in Equations (5) and (6) denotes a sub-frame length (5 milliseconds). The values d(n) and φ(i,j) are calculated before the algebraic codebook searching operation.

### Equation 5

$$d ( n ) = {\sum }_{i = n}^{N - 1} {x}^{′} ( i ) a ( i - n ) , \begin{matrix} & & n = 0 , … , N - 1\end{matrix} \qquad ( 5 )$$

### Equation 6

$$\begin{matrix}φ ( i , j ) = {\sum }_{n = j}^{N - 1} a ( n - i ) a ( n - j ) , & & i = 0 , … , N - 1 , & j = i , … , N - 1\end{matrix} \qquad ( 6 )$$

In these equations, when the number of pulses included in a code vector for outputting the algebraic codebook output C is represented by N_{P}, a correlation Q between a target vector X′ and the algebraic codebook output C can be expressed by the following Equation (7).

### Equation 7

$$Q = {\sum }_{i = 0}^{{N}_{p} - 1} s ( i ) d ( m ( i ) ) \qquad ( 7 )$$

In Equation (7), s(i) denotes the amplitude of the ith pulse of the algebraic codebook output C, and m(i) denotes the position of the pulse. The autocorrelation E of the algebraic codebook output C can be expressed by Equation (8).

### Equation 8

$$E = {\sum }_{i = 0}^{{N}_{p} - 1} φ ( m ( i ) , m ( i ) ) + 2 {\sum }_{i = 0}^{{N}_{p} - 2} {\sum }_{j = i + 1}^{{N}_{p} - 1} s ( i ) s ( j ) φ ( m ( i ) , m ( j ) ) \qquad ( 8 )$$

Therefore, in a state in which a value in a pulse sequence group in which embedded data is embedded is fixed to a value equal to the value of the embedded data Scode (i.e., a state in which the values of the groups i0 to i2 are fixed to the embedded data in this embodiment, that is, m(0), . . . , m(2) s(0), . . . , s(2) of Equations (7) and (8) are fixed to the embedded data), the correlations Q and E are calculated while changing the positions m3 to m9 of the pulses and the amplitudes s3 to s9, and a pulse position and an amplitude are determined such that D′ of Equation (4) is maximum.

In this manner, the algebraic code quantizer 34 calculates the algebraic codebook output C of AMR which can obtain a target vector X′ at which an error power D with respect to the reproduced signal X is minimum from the limited conversion candidates, determines a quantization index of the calculated algebraic codebook output C as a converted algebraic code (algebraic code 2), and outputs the quantization index.

As described above, the algebraic code converting unit 26 limits algebraic codes of AMR to be converted depending on embedded data included in an algebraic code of G.729A and determines an optimum algebraic code in the algebraic codes.

### Operation

An operation of the concrete example (speech transcoder 20) of the first embodiment will be described below.

In the speech transcoder 20, the embedded data extracting unit 28 extracts the embedded data Scode embedded in information fields corresponding to i0 to i2 of algebraic code 1 and give the embedded data Scode to the converted code limiting unit 29. The converted code limiting unit 29 limits the plurality of algebraic codes stored in the algebraic codebook 31 to algebraic codes having values of i0 to i2 which are equal to those of the embedded data Scode. In this manner, the conversion candidates of algebraic code 1 are limited. Therefore, converted algebraic codes from the algebraic codebook 31, i.e., algebraic codes determined as the algebraic code 2 are set in a state in which the embedded data Scode are always embedded in the information fields of i0 to i2.

As described above, according to the speech transcoder 20, algebraic code 1 can be converted into algebraic code 2 in which the embedded data Scode included in algebraic code 1 is embedded In this manner, the embedded data Scode embedded in algebraic code 1 can be maintained in algebraic code 2.

Therefore, a destination node of the speech code bst2 (m) extracts information of i0, i1, and i2 of the algebraic code of AMR according to the embedding position of known embedded data, so that the data embedded in the algebraic code of G.729A can be correctly received.

Limitations of the conversion candidate make it possible to shorten time required for searching an algebraic codebook.

In, the speech transcoder 20, the algebraic code converting unit 26 determines a quantization index of a decoded value having a minimum error with respect to the decoded value of algebraic code 1 in the limited conversion candidates as a converted algebraic code (algebraic code 2). In this manner, since an optimum converted algebraic code is selected from the limited conversion candidates, voice quality can be suppressed from being deteriorated by conversion of a speech code.

For this reason, the embedded data embedded in the algebraic code of G.729A can be converted into a speech code of AMR without being deteriorated by algebraic code converting such that deterioration of voice quality is suppressed to a minimum level.

In addition, the embedding position of the embedded data is defined in parts (common parts) having the same structures in G.729A and AMR, i.e., information fields of the pulse sequence groups i0 to i2. The values represented by the groups i0 to i2 of algebraic code directly constitute the contents of common parts (i0 to i2) of algebraic code 2. Therefore, the contents of the converted algebraic code 2 can be made close to the contents of algebraic code 1. For this reason, deterioration of speech code caused by code conversion can be suppressed as hard as possible.

### SECOND EMBODIMENT

As the second embodiment of the present invention, an embodiment corresponding to the second aspect of the present invention will be described below. In the second embodiment, a speech transcoder which does not embed embedded data embedded in a speech code of the first encoding method but embeds embedded data (for example, data received through a data circuit) obtained by another method in a speech code of the second encoding method corresponding to a converted speech code of the first encoding method. Since the second embodiment includes parts common in the first embodiment, different points between the first embodiment and the second embodiment will be mainly described below.

### Outline of Second Embodiment

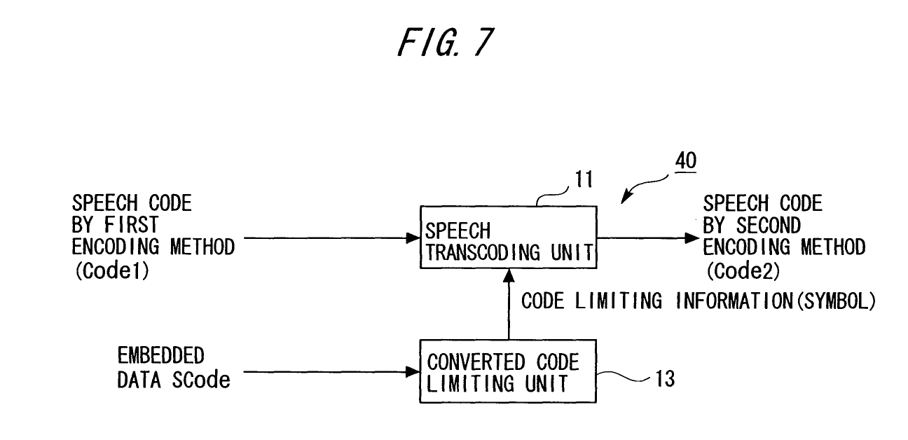

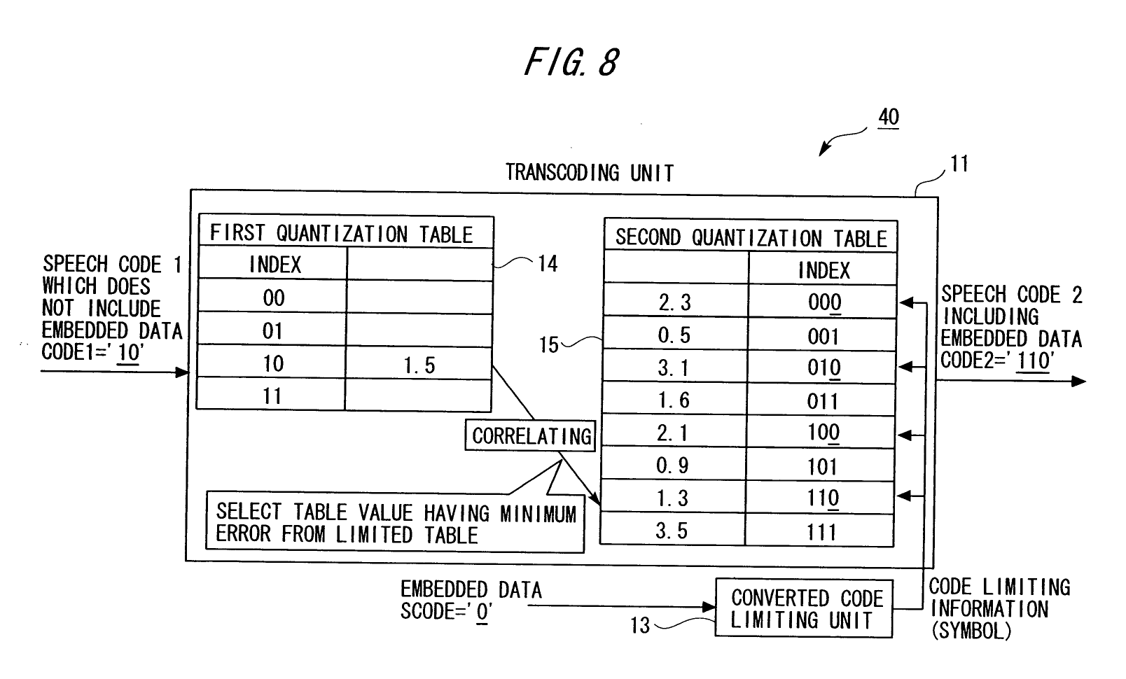

FIG. 7 is a schematic diagram showing the principle of the second embodiment (speech transcoder 40) of the present invention. FIG. 8 is a diagram showing the further details of the speech transcoder 40 shown in FIG. 7. The speech transcoder 40 has the same configuration as that of the speech transcoder 10 of the first embodiment except for the following points.

(1) The speech transcoder 40 does not have an embedded data extracting unit for extracting embedded data from a speech code (speech code Code1) of the first encoding method input to the speech transcoder 40.

(2) Arbitrary embedded data Scode embedded in a converted speech code (speech code Code2) of speech code Code1 is input to the conversion code limiting unit 13. The embedded data Scode is input to the conversion code limiting unit 13 through a circuit different from the circuit of the speech code.

In FIG. 8, the speech code Code1 (“10” in FIG. 8) input to the speech transcoding unit 11 represents an index number of the first quantization table 14. The speech code Code2 represents the index number of the second quantization table 15. The lower m bits of the series data constituting the speech code Code2 represent embedded series data.

The operation of the speech transcoder 40 is as follows. First, the embedded data Scode (“0” in FIG. 8) received from a circuit (data circuit) different from the speech code circuit is input to the conversion code limiting unit 13.

The conversion code limiting unit 13 does not set objects to be converted (conversion candidates) as all the table (index numbers) of the second quantization table 15, and limits the object to be converted to only tables in which the series data of the lower m bits of the index numbers is equal to the embedded data Scode.

Thereafter, the speech transcoding unit 11 selects (determines) a table value having a minimum error with respect to the table value of the first quantization table 14 corresponding to the speech code Code1 input to the speech transcoding unit 11 from the limited conversion candidates of the second quantization table 15 and outputs the index number (“110” in FIG. 8) corresponding to the selected table value as the speech code (encoded data) Code2 of the second encoding method.

According to the speech transcoder 40 of the second aspect, in conversion of a speech code, when the embedded data Scode is input, the speech transcoding unit 11 converts the speech code Code1 into the speech code Code2 in which the embedded data Scode is embedded. In this manner, according to the speech transcoder 40, arbitrary series data can be embedded in the speech code of the second voice encoding method.

Furthermore, according to the speech transcoder 40, the speech transcoding unit 11 selects a table value (index corresponding thereto) having a minimum error with respect to the table value of the first quantization table 14 corresponding to the speech code Code2 from the second. quantization table 15 in which conversion candidates are limited. In this manner, the deterioration of the quality of voice by inserting the embedded series data into the speech code can be suppressed to the minimum.

For this reason, in the speech transcoding unit, speech code 1 of the first encoding method is converted into speech code 2 of the second encoding method, and arbitrary series data can be embedded in speech code 2 of the second encoding method while suppressing deterioration of sound quality.

In the description in FIG. 8, for descriptive convenience, it is assumed that the embedded series data is included in the lower m bits. However, the position where the embedded series data is included and the number of bits are arbitrarily set. A route for acquiring the embedded data input to the conversion code limiting unit 13 is arbitrarily set.

### Concrete Example

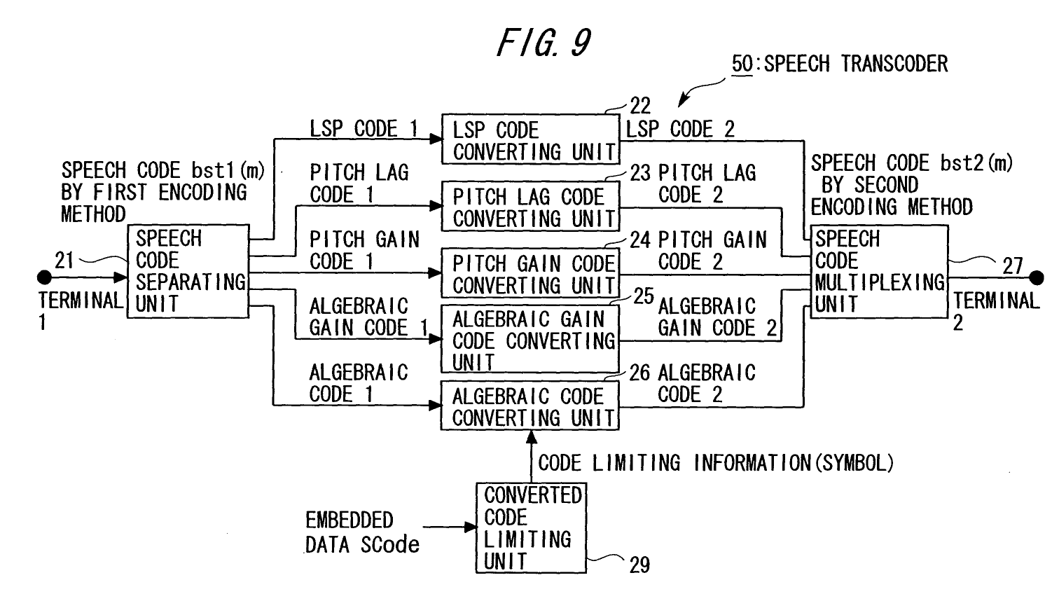

An concrete example of the second embodiment (second invention) will be described below. FIG. 9 is a diagram showing the configuration of a speech transcoder (speech transcoding device) 50 corresponding to a concrete example of the second embodiment. In this concrete example, G.729A is applied as the first encoding method, and AMR (12.2 kbps mode) is applied as the second encoding method. The speech transcoder 50 embeds arbitrary data in an algebraic code of AMR when an algebraic code of G.729A is converted into an algebraic code of AMR. More specifically, an algebraic code of G.729A is converted into an algebraic code of AMR in which arbitrary data is embedded.

In FIG. 9, the speech transcoder 50 is different from the speech transcoder 20 in the first embodiment in the following points:

(1) The speech transcoder 50 includes no embedded data extracting unit.

(2) Arbitrary embedded data Scode is input to a converted code limiting unit 29.

More specifically, circuit data bst1 (m) serving as an encoder output of G.729A of the mth frame is input to the speech code separating unit 21 through the terminal 1. The speech code separating unit 21 separates the circuit data bst1(m) into element codes (LSP code, pitch lag code, pitch gain code, algebraic code, and algebraic gain code) of G.729A and inputs the element codes to the respective code converting units 22 to 26 (the LSP code converting unit 22, the pitch lag code converting unit 23, the pitch gain code converting unit 24, the algebraic code converting unit 26, and the algebraic gain code converting unit 25). Arbitrary embedded data Scode is input to the converted code limiting unit 29. The embedded data Scode is input to the speech transcoder 50 through, e.g., another data circuit.

The converted code limiting unit 29 limits algebraic codes of AMR serving as objects to be converted (conversion candidates) depending on the embedded data Scode. In each transcoding unit, each of the input element codes of G.729A is converted into each element code of AMR to output the element code of AMR to a code multiplexing unit. The code multiplexing unit multiplexes the converted element code of AMR to output the multiplexed element code as a circuit data bst2(n) of the nth frame of AMR.

In this case, the configurations and operations of the code converting units 22 to 26 are the same as those of the fist embodiment (speech transcoder 20). The converted code limiting unit 29 in the second embodiment is different from that the converted code limiting unit 29 in the first embodiment in that input data is not embedded data extracted from an algebraic code of G.729A but arbitrary embedded data.

An amount of data and an input frequency of the arbitrary embedded data input to the converted code limiting unit 29 may be arbitrarily set. The amount of data may be fixed, and the input frequency may be adaptively controlled (e.g., controlled depending on the nature or the like of the parameters of G.729A). The data length of the embedded data is desirably set to be a data length corresponding to pulse information (position information and amplitude information) of an algebraic codebook of AMR. For example, when the data is embedded in pulses i0 and i1, the data length is set to be 8 bits, i.e., (4+4) bits.

### Operation

According to the concrete example of the second embodiment, when algebraic code data of G.729A is not embedded, embedded data is directly input to a converted code limiting unit to limit algebraic codes of AMR to be converted. An optimum algebraic code is determined in the algebraic codes to minimize deterioration of voice quality, and arbitrary data can be embedded in a speech code of AMR.

When data is actually embedded in a speech code, a frame suitable for an embedding operation, i.e., a frame which slightly affects quality of voice even though the code is replaced with arbitrary data is selected. In this manner, the deterioration of the quality of voice can be further suppressed. As the selection method, for example, as disclosed in Japanese Patent Application No. 2002-26958, a method of embedding data by using an algebraic gain as a factor representing a degree of contribution of an algebraic code only when the algebraic gain is equal to or lower than a predetermined threshold value or other methods are known.

In the first and second embodiments of the present invention, examples suitable for the speech transcoding methods shown in FIGS. 12 and 13 are shown. However, the present invention can also be applied to a transcoding method of a tandem connection method.

In the future, with the popularization of the third-generation mobile telephone system and VoIP, in communication between variable communication systems such as between a mobile telephone having a conventional voice circuit and a third-generation mobile telephone having a voice circuit and a data circuit or between a third-generation mobile telephone and a VoIP, the necessity of a technique using a data embedding technique and a speech transcoding technique is high. At this time, the necessity of the present invention for performing speech transcoding in which the following two points are compatible is high:

(1) Embedded data is not damaged, or new arbitrary data can be embedded in the second speech code;

(2) Deterioration of voice quality is suppressed.

According to the speech transcoder of the present invention, quality of voice can be suppressed from being deteriorated even though a speech code of the first encoding method in which arbitrary data is not embedded is used.

### THIRD EMBODIMENT

The third embodiment of the present invention will be described below. The third embodiment will describe a speech encoder (voice encoding device) which embeds arbitrary embedded data in a speech code by the same principle as that of the second embodiment.

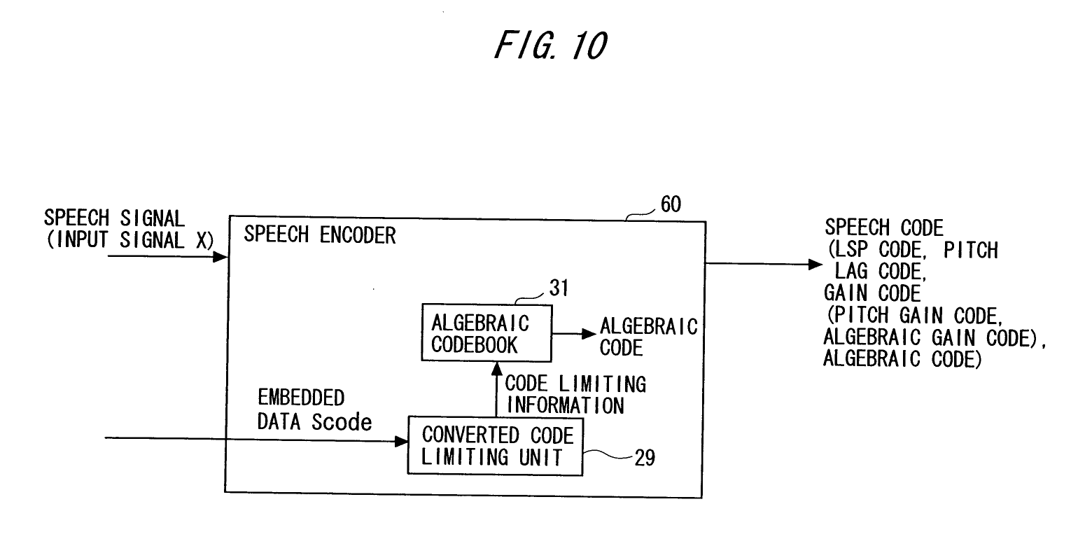

FIG. 10 is a diagram showing a configuration of a speech encoder 60. The speech encoder 60 encodes a speech signal into a speech code in conformity to a predetermined voice encoding method (G.729A, AMR, or the like). In this example, the speech encoder 60 encodes a speech signal in conformity to AMR (12.2 kbps).

A speech signal and embedded data Scode are input to the speech encoder 60. The speech encoder 60 has a configuration which is almost the same as that of an encoder of AMR. The speech encoder 60 uses the input speech signal as an input signal X to generate an LSP code, a pitch lag code, a gain code (pitch gain code or algebraic gain code), and an algebraic code corresponding to the input signal X. The speech encoder 60 multiplexes these codes and outputs the multiplexed codes as speech codes.

The speech encoder 60 comprises a converted code limiting unit 29 having the same configuration as that of the second embodiment. Embedded data Scode is input to the converted code limiting unit 29. The converted code limiting unit 29 generates and outputs code limiting information as in the second embodiment. According to the code limiting information, algebraic codes (conversion candidates (encoding candidates)) of the algebraic codebook 31 are limited to an algebraic code having a value equal to that of the embedded series data Scode at a predetermined position (for example, pieces of pulse information i0 to i3).

Thereafter, the speech encoder 60 searches an algebraic codebook for an algebraic code obtained by encoding a noise component of an input signal X. More specifically, a quantization index of an algebraic codebook output when a target vector X′ having a minimum error power with respect to the input signal X is obtained is determined as a converted (encoded) algebraic code. At this time, since the algebraic code used as a conversion candidate in the algebraic code searching operation has a value equal to that of the embedded data, an algebraic code to be determined (selected) must include the embedded data.

### Operation

According to the third embodiment, a speech signal can be encoded into a speech code in which embedded data is embedded. At this time, an optimum algebraic code is selected as the noise component of the input signal X from the algebraic codes limited by the conversion code limiting unit 29. Therefore, deterioration of quality of voice caused by embedding the embedded data can be suppressed to the minimum when the speech signal is encoded.

In addition, as in the first and second embodiments, by using an algebraic gain or the like, data is embedded by selecting a frame which slightly affects voice quality, so that voice can be more suppressed from being deteriorated.

According to the speech transcoder of the present invention, when a speech code of the first encoding method is converted into a speech code of the second encoding method, the speech code of the first encoding method can be converted into a speech code of the second encoding method in which arbitrary data is embedded.

According to the speech transcoder of the present invention, when a speech code of the first voice encoding method is converted into a speech code of the second encoding method, arbitrary data can be embedded in the speech code of the second encoding method while suppressing sound quality from being deteriorated.

According to the speech encoder of the present invention, when a speech signal is encoded into a speech code, the speech signal can be encoded into a speech code in which arbitrary data is embedded.

What is claimed is:

1. A speech transcoder which converts a first speech code encoded by a first encoding method into a second speech code encoded by a second encoding method, comprising:
extracting means for extracting embedded data embedded in an element code constituting the first speech code;
a codebook for storing a plurality of element codes encoded by the second encoding method to serve as conversion candidates of the element code of the first speech code;
limiting means for limiting the plurality of element codes stored in the codebook to at least one element code having a value equal to that of the embedded data extracted by the extraction means at a predetermined position to limit the conversion candidates; and
determining means for determining an element code corresponding to a converted speech code from the conversion candidates limited by the limiting means.

2. A speech transcoder according to claim 1, wherein all of or a part of the element codes encoded by the first encoding method has the same configuration as that of the element code encoded by the second encoding method, and the embedded data is embedded in a portion having the same configuration of the element code encoded by the first encoding method, and
the limiting means limits the conversion candidates to an element code in which the value at the same position as an embedding position of the data embedded in the element code encoded by the first encoding method is equal to the value of the embedded data.

3. A speech transcoder according to claim 1, wherein the determining means determines an element code obtained by encoding, in conformity to the second encoding method, an inversely quantized value having a minimum error with respect to an inversely quantized value of the element code constituting the first speech code as an element code corresponding to a converted speech code.

4. A speech transcoder according to claim 1, wherein the determining means determines an element code which can obtain a speech signal having a minimum error power with respect to a reproduced signal obtained by decoding the first speech code as an element code corresponding to a converted speech code.

5. A speech transcoder which converts a first speech code encoded by a first encoding method into a second speech code encoded by a second encoding method, comprising:
a codebook for storing a plurality of element codes encoded by the second encoding method to serve as conversion candidates of the element code constituting the first speech code;
limiting means for limiting the plurality of element codes stored in the codebook to at least one element code having a value equal to that of the embedded data embedded in the second speech code at a predetermined position to limit the conversion candidates; and
determining means for determining an element code corresponding to a converted speech code in the conversion candidates limited by the limiting means.

6. A speech transcoder according to claim 5, further comprising:
embedded data extracting means for extracting the embedded data embedded in the element code constituting the first speech code to give the embedded data to the limiting means.

7. A speech transcoder according to claim 5, wherein the determining means determines an element code obtained by encoding, in conformity to the second encoding method, an inversely quantized value having a minimum error with respect to an inversely quantized value of the element code constituting the first speech code as an element code corresponding to a converted speech code.

8. A speech transcoder according to claim 5, wherein the determining means determines an element code which can obtain a speech signal having a minimum error power with respect to a reproduced signal obtained by decoding the first speech code as an element code corresponding to a converted speech code.

9. A speech encoder for encoding a speech signal into a speech code comprising:
a codebook in which a plurality of element codes obtained by encoding a specific component of the speech signal;
limiting means for limiting the plurality of element codes stored in the codebook to at least one element code having a value equal to that of embedded data embedded in the speech code at a predetermined position to limit the encoding candidates of the specific component; and
determining means for determining an element code corresponding to an encoded speech code of the specific component in the encoding candidates limited by the limiting means.

10. A speech encoder according to claim 9, wherein the determining means determines an element code which can obtain a speech signal having a minimum error power with respect to a speech signal to be encoded as an element code corresponding to the encoded speech code of the specific component.

11. A speech transcoding method which converts a first speech code encoded by a first encoding method into a second speech code encoded by a second encoding method, comprising:
extracting embedded data embedded in an element code constituting the first speech code;
limiting a plurality of element codes encoded by the second encoding method and stored in a codebook to serve as conversion candidates of the element code of the first speech code to at least one element code having a value equal to that of the extracted embedded data at a predetermined position to limit the conversion candidates of the element code of the first speech code; and
determining an element code corresponding to a converted speech code in the limited conversion candidates.

12. A speech transcoding method according to claim 11, wherein all or a part of the element codes encoded by the first encoding method has the same configuration as that of the element code encoded by the second encoding method, and the embedded data is embedded in a portion having the same configuration of the element codes encoded by the first encoding method, and
the limiting step limits the conversion candidates to an element code in which the value at the same position as an embedding position of the data embedded in the element code encoded by the first encoding method is equal to the value of the embedded data.

13. A speech transcoding method according to claim 10, wherein the determining step determines an element code obtained by encoding, in conformity to the second encoding method, an inversely quantized value having a minimum error with respect to an inversely quantized value of the element code constituting the first speech code as an element code corresponding to a converted speech code.

14. A speech transcoding method according to claim 10, wherein the determining step determines an element code which can obtain a speech signal having a minimum error power with respect to a reproduced signal obtained by decoding the first speech code as an element code corresponding to a converted speech code.

15. A speech transcoding method which converts a first speech code encoded by a first encoding method into a second speech code encoded by a second encoding method, comprising:
limiting the plurality of element codes encoded by the second encoding method and stored in a codebook to serve as conversion candidates of the element code constituting the first speech code to at least one element code having a value equal to that of the embedded data embedded in the second speech code at a predetermined position to limit the conversion candidates; and
determining an element code corresponding to a converted speech code from the conversion candidates limited by the limiting step.

16. A speech transcoding method according to claim 15, further comprising:
the step of extracting the embedded data embedded in the element code constituting the first speech code, and wherein the limiting step limits the conversion candidates depending on the extracted embedded data.

17. A speech transcoding method according to claim 15, wherein the determining step determines an element code obtained by encoding, in conformity to the second encoding method, an inversely quantized value having a minimum error with respect to an inversely quantized value of the element code constituting the first speech code as an element code corresponding to the converted speech code.

18. A speech transcoding method according to claim 15, wherein the determining step determines an element code which can obtain a speech signal having a minimum error power with respect to a reproduced signal obtained by decoding the first speech code as an element code corresponding to a converted speech code.

19. A speech encoding method for encoding a speech signal into a speech code comprising:
limiting the plurality of element codes stored in a codebook and obtained by encoding a specific component of the speech signal to at least one element code having a value equal to that of embedded data embedded in the speech code at a predetermined position to limit encoding candidates of the specific component; and
determining an element code corresponding to an encoded speech code of the specific component from the limited encoding candidates.

20. A speech encoding method according to claim 19, wherein the determining step determines an element code which can obtain a speech signal having a minimum error power with respect to a speech signal to be encoded as an element code corresponding to the encoded speech code of the specific component.
